(19) United States
(12) Patent Application Publication
(10) Pub. No.: US 2010/0218619 A1
(43) Pub. Date: Sep. 2, 2010

(54) DRIVE TORQUE SENSING WHEEL END

(75) Inventor: John D. Dougherty, Canton, OH (US)

Correspondence Address: Polster, Lieder, Woodruff & Lucchesi, L.C., 12412 Powerscourt Dr. Suite 200, St. Louis, MO, 63131-3615, US

(73) Assignee: THE TIMKEN COMPANY, Canton, OH (US)

(21) Appl. No.: 12/682,144

(22) PCT Filed: Oct. 20, 2008
(86) PCT No.: PCT/US08/80451

§ 371 Date: Apr. 8, 2010

Related U.S. Application Data
(60) Provisional application No. 60/981,612, filed on Oct. 22, 2007.

(51) Int. Cl. G01L 3/10; F16C 32/04

(52) U.S. Cl. 73/862.335; 384/448

(57) ABSTRACT

A sensing system for sensing the drive torque applied to a vehicle wheel end assembly (100). The sensor system (200) is integrated into the internal spaces of the bearing assembly (103) within vehicle wheel end assembly (100), and is protected from environmental conditions. The sensor system (200) incorporates a pair of spaced-apart sensing elements (202a, 202b) disposed on a stationary member (104) of the vehicle wheel end assembly (100) in alignment with the axis or rotation. A target element (300) disposed on the rotating member (102) of the vehicle wheel end assembly (100). Each sensing element (202a, 202b) generates a signal which is responsive to the passage of the target element (300), at a frequency which is proportional to the rotational speed of the wheel end assembly (100). Torsional twist of the rotating wheel end hub member (102) resulting from the application of a drive torque is registered as a phase shift between the signal output from each of the sensing elements (202a, 202b) which can be monitored as a measure of the drive torque applied to the vehicle wheel end assembly (100).

### CROSS-REFERENCE TO RELATED APPLICATIONS

The present application is related to, and claims priority from, U.S. Provisional Patent Application Ser. No. 60/981,612 filed on Oct. 22, 2007, which is herein incorporated by reference.

### STATEMENT REGARDING FEDERALLY SPONSORED RESEARCH

Not Applicable.

### BACKGROUND OF THE INVENTION

The present invention is related generally to vehicle wheel end assemblies, and in particular, to a wheel end assembly which incorporate sensors for measuring wheel end characteristics which vary in response to drive torque applied to the wheel end assembly.

In many automotive vehicles of current manufacture the road wheels are coupled to the suspension system of the vehicle through conventional bearing assemblies commonly referred to as wheel ends. Conventional wheel ends, such as shown in FIG. 1 are utilized irrespective of whether the wheels are driven or non-driven wheels. The typical wheel end 100 includes a housing 104, a hub 102 that rotates in and beyond the housing 104, and an antifriction bearing assembly 103 located between the hub 102 and the housing 104. The housing 104 is attached to a suspension element 105 on the vehicle, whereas a road wheel assembly is secured at a wheel rim to an outboard flange 114 of the rotating hub 102. The antifriction bearing assembly 103 must have the capacity to transfer radial loads between the housing 104 and the hub 102, and also axial or thrust loads in both axial directions. To achieve the necessary load transfers, the antifriction bearing assembly 103 traditionally incorporates rolling elements 103a arranged in two rows, with the rolling elements 103a of the one row operating along raceways inclined in one direction and with the rolling elements 103a of the other row operating along raceways inclined in the opposite direction. Typically, manufactures supply the wheel ends 100 directly to the vehicle manufacturers as pre-packaged assemblies with the tolerance of the antifriction bearings preset and with the antifriction bearings pre-lubricated.

Some wheel ends 100 have speed sensors attached to their housings and target wheels carried by the associated rotating hubs. The speed sensors monitor the rotation of the target wheels coupled to the rotating hub 102—and hence the rotation of the attached road wheels—and thus provide signals reflecting angular velocity of the road wheels which may be utilized by various anti-lock braking systems (ABS) and traction control systems (TCS) onboard the vehicle.

To maintain even more control over vehicle performance, some vehicles have electronic dynamic or stability control systems (ECS) which operate to maintain vehicle stability. These systems may manage drive train power, braking, steering, and even suspension system components, and hence enhance vehicle safety and performance. These types of systems will function best when provided with reliable information associated with the loads at the so-called tire patches for a vehicle, that is, where the tires of the road wheels contact the road surface, and these loads are essentially loads transmitted through the wheel ends 100 for the vehicle. For example, maneuvering through a turn will create thrust loads at the wheel ends 100 and laterally directed forces at the tire patches, and these represent the most critical aspects of dynamic control.

The advancement from anti-lock brake system (ABS) and traction control systems (TCS) to electronic stability control systems (ECS) has required additional vehicle condition sensing capabilities. All of these systems can benefit from knowledge of the driving torque acting at each wheel of a vehicle.

Traditional systems for measuring drive torque applied to a vehicle wheel utilize sensors which are external to the wheel end antifriction bearing assembly. For example, some systems sense torque on an interconnecting drive shaft that leads into a constant velocity (CV) joint coupling the wheel end assembly 100 to a main drive shaft. Torque sensors in this location are subject to the harsh environmental conditions experienced by the vehicle, and require additional assembly steps to be carried out either during vehicle assembly or during the manufacture of the CV joint components.

Accordingly, it would be advantageous to provide a sensor for measuring characteristics representative of the drive torque applied to a wheel end 100 which is not external to the wheel end assembly 100, and which does not require additional time or labor to install during vehicle manufacture or assembly.

### BRIEF SUMMARY OF THE INVENTION

Briefly stated, the present disclosure provides a system for sensing the drive torque applied to a vehicle wheel end assembly internally within the wheel end. The sensor system is integrated into the internal spaces of the antifriction bearing within vehicle wheel end assembly, and is protected from environmental conditions. The sensor system incorporates a pair of sensing elements disposed on a stationary member of the vehicle wheel end assembly, and a target element disposed in proximity thereto on a rotating member of the vehicle wheel end assembly. Each sensing element generates a signal which is responsive to the passage of the target element, at a frequency which is proportional to the rotational speed of the wheel speed. Torsional twist of the wheel end hub member resulting from the application of a drive torque is registered as a phase shift between the signal output from each of the sensing elements, enabling the sensor system monitors the phase shift of the output signals as a measure of the drive torque applied to the vehicle wheel end assembly.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a cross-sectional view of a prior art driven vehicle wheel end assembly;

FIG. 2 is a cross-sectional view of a portion of a vehicle wheel end assembly incorporating a pair of sensors and separate target members of the present disclosure within the bearing assembly;

FIG. 3A is a view of a first embodiment of a target member;

FIG. 3B is a view of a second embodiment of a target member;

FIG. 4 is a partial cross-sectional view of a vehicle wheel end assembly incorporating an alternate embodiment sensor assembly of the present disclosure incorporating a pair of sensing elements within one sensor probe and a single target member; and

FIG. 5 is an enlarged view of the cross-sectional representation of the vehicle wheel hub shown in FIG. 4 that utilizes an alternative target design.

Corresponding reference numerals indicate corresponding parts throughout the several figures of the drawings. It is to be understood that the drawings are for illustrating the concepts set forth in the present disclosure and are not to scale. Further, the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

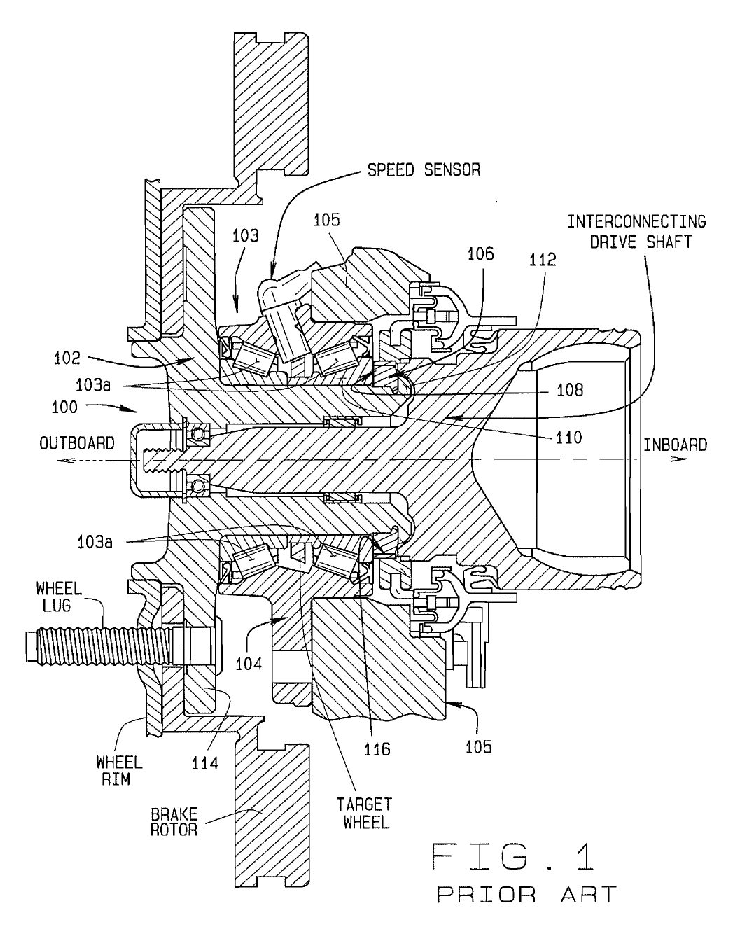

Turning to the figures, and to FIG. 1 in particular, a wheel end assembly 100, consists generally of a hub 102 and bearing assembly 103 disposed within a housing 104 is shown with a drive coupler 106 between a back face 108 of an inboard cone 110 and a formed end 112 of the hub 102. Driving torque for a road wheel assembly consisting of a wheel rim and tire secured to an outboard flange 114 of the hub 102 is applied to the outer diameter splines 116 of the drive coupler 106, and is resisted by the tractive effort that occurs at the tire patch of the vehicle wheel mounted to the wheel rim. This torsional loading across the wheel end hub 102 produces a torsional twist in the hub 102.

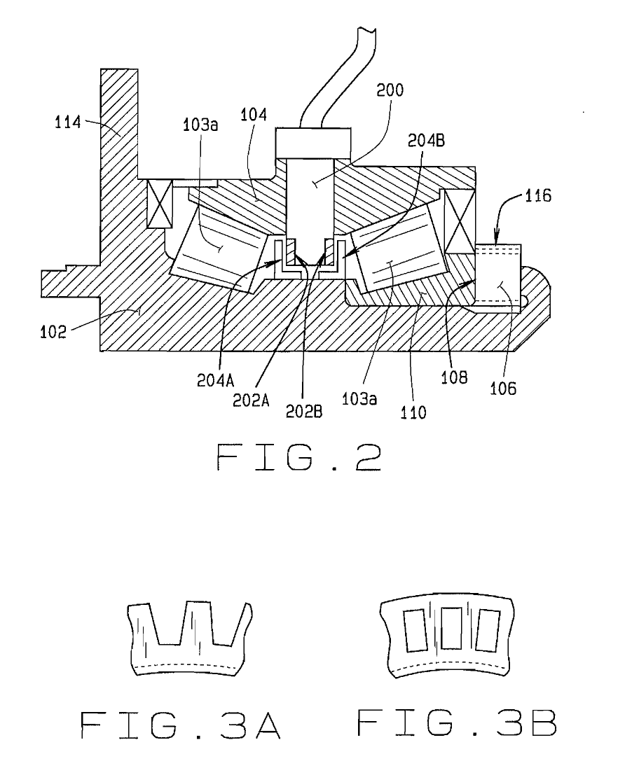

Torsional twist in the hub 102 can be measured using a sensor 200 with two sensing elements 202a and 202b spaced apart along the rotational axis of the bearing assembly 103 by a set distance. As is seen in FIG. 2, two ASIC-type sensing elements on both sides of a sensor 200 disposed between the rows of rolling elements 103a within the bearing assembly 103 are disposed to each sense the passage of associated magnetic encoders 204a and 204b with alternating north and south poles associated with the rotating hub 102 of the bearing assembly 103. Alternatively, the sensor probe 200 can have a back biasing magnet that enables the magnetic encoders 204a and 204b to be replaced by stamped target wheels that have perforations or gear teeth punched into them, such a shown in FIGS. 3A and 3B.

During rotation of the wheel end hub 102, each sensing element 202a and 202b produces a signal with a frequency which is proportional to the speed at which the magnetic encoders 204a and 204b rotate, i.e. the wheel speed. The torsional twist exerted on the wheel end hub 100 by the application of a drive torque will cause a phase shift to occur between the signals produced at each sensing element 202a and 202b, which are spaced in a known configuration aligned with the rotational axis of the wheel end hub 100. The relationship between the drive torque, torsional twist, and the observed phase shift is experimentally determined for each type of wheel end assembly 100 to enable the drive torque to be measured within the sealed environment of the hub and bearing assembly 100.

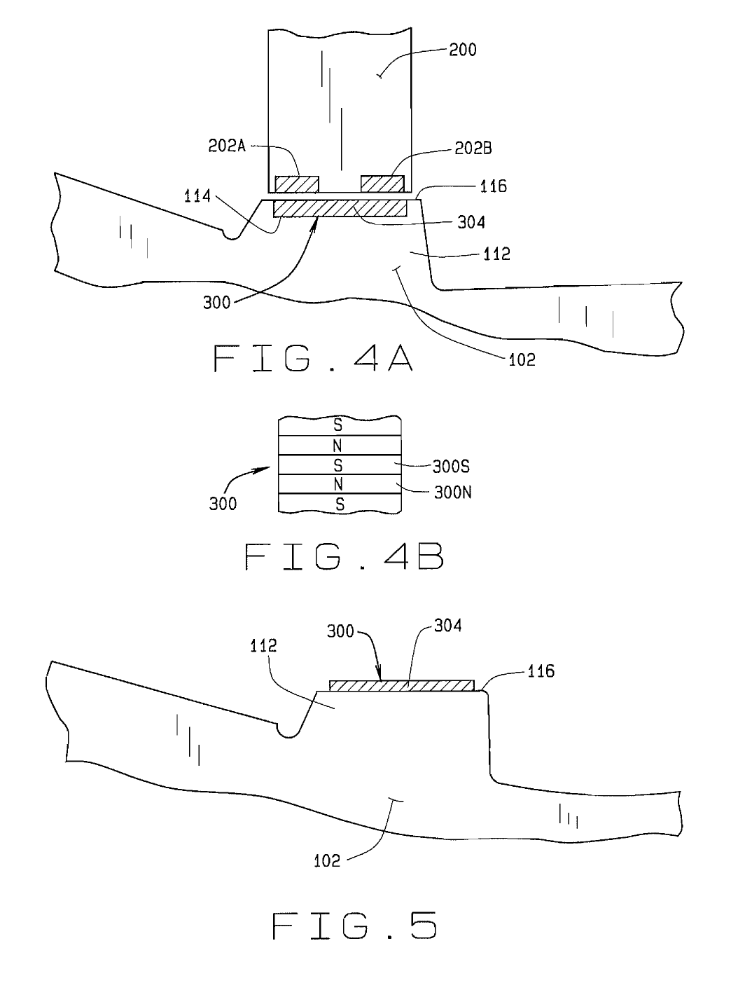

Turning to FIGS. 4 and 5, an alternate embodiment of the present disclosure is shown which utilizes a single common target 300 disposed on an outer circumference of an integral rib 112 disposed between the bearings 103a on the wheel end hub 102. The single common target 300 may be disposed in an annular groove 114 machined into the outer diameter surface 116 of the integral rib 112, or may be applied directly onto the outer diameter surface 116. In the embodiment shown in FIG. 4, the annular groove 114 in the outer diameter 116 of the integral rib 112 is utilized to secure, such as by molding, a magnetic material 304 onto the hub 102. The magnetic material 304 then magnetized to define the magnetic encoder 300 with alternating north and south poles 300N and 300S, having a longitudinal axis parallel to the axis of rotation of the wheel end assembly 100. Drive torque applied to the wheel end assembly 100 causes the magnetic poles to twist away from alignment with the axis of rotation of the wheel end hub 102 due to the torsional forces. The sensor probe 200 with the two sensing elements 202a and 202b spaced a known distance apart along the axis of rotation is utilized to detect the twist or misalignment as a phase shift between the output of each sensing element 202a and 202b during rotation of the wheel end hub 102. The relationship between the drive torque, the torsional twist, and phase shift is experimentally determined to enable the drive torque to be measured within the sealed environment of the hub and bearing assembly 100.

As various changes could be made in the above constructions without departing from the scope of the disclosure, it is intended that all matter contained in the above description or shown in the accompanying drawings shall be interpreted as illustrative and not in a limiting sense.

1. A drive torque sensor for a driven wheel end having outboard and inboard ends including a housing, a rotating hub having a spindle that extends into the housing and a coupling for receiving drive torque, and a bearing assembly located between the housing and the rotating hub to enable the hub to rotate relative to the housing about an axis of rotation, the bearing assembly being configured to transfer loads between the housing and the rotating hub, comprising:
a target assembly carried within said bearing assembly by the rotating hub for rotation with the hub;
a sensor assembly carried within said bearing assembly by the housing and presented toward the target assembly, the sensor assembly having at least two sensing elements displaced from each other along an axis parallel to the axis of rotation of the rotating hub; and
wherein each of said sensing elements is configured to generate a signal representative of the rotational passage of said target assembly past said sensing elements, a frequency of said signals from each of said sensing elements being representative of a rotational speed of said target assembly, and a phase shift between an output signal from each of said sensing elements being proportional to a drive torque exerted on said rotating hub.

2. The drive torque sensor of claim 1 wherein said sensor assembly includes a pair of ASIC-type sensing elements.

3. The drive torque sensor of claim 1 wherein said target assembly includes a first target wheel and a second target wheel, said first and second target wheels aligned relative to each other about said axis of rotation in a spaced configuration on the rotating hub.

4. The drive torque sensor of claim 3 wherein each of said target wheels includes a plurality of aligned north and south magnetic poles.

5. The drive torque sensor of claim 3 wherein said sensor assembly includes a back-bias magnet and each of said first and second target wheels includes a plurality of aligned perforations.

6. The drive torque sensor of claim 1 wherein said target assembly includes a plurality of north and south magnetic poles disposed about an outer diameter of said rotating hub in operative proximity to said sensor assembly, each of said magnetic poles configured for detection by each of said sensing elements.

7. The drive torque sensor of claim 6 wherein each of said magnetic poles has a axially elongated configuration with an axial dimension at least equal to an axial displacement between each of said sensing elements.

8. The drive torque sensor of claim 6 wherein said target assembly is disposed on an outer diameter surface of said rotating hub.

9. The drive torque sensor of claim 6 wherein said target assembly is disposed within an annular channel in an outer diameter surface of said rotating hub.

10. The drive torque sensor of claim 6 wherein said target assembly is composed of a molded magnetic material.

11. A method for measuring torque within a vehicle wheel end assembly having a housing, a rotating hub within the housing, and a bearing assembly located between the housing and the rotating hub to enable the hub to rotate relative to the housing about an axis of rotation, the bearing assembly being configured to transfer loads between the housing and the rotating hub, comprising:
associating a target assembly with said rotating hub within said bearing assembly for rotation with the rotating hub;
disposing a sensor assembly on said housing in a stationary configuration within said bearing assembly for monitoring said target assembly, the sensor assembly having at least two sensing elements displaced from each other along an axis parallel to the axis of rotation of the rotating hub; and
generating signals representative of the rotational passage of said target assembly past each of said sensing elements;
measuring a frequency of said signals from each of said sensing elements as being representative of a rotational speed of said target assembly; and
measuring a phase shift between each of said signals as being representative of a drive torque exerted on said rotating hub.

12. The method for measuring torque of claim 11 further including the step of quantifying the relationship between said measured phase shift and said drive torque.
